(19) United States
(12) Patent Application Publication
(10) Pub. No.: US 2010/0019869 A1
(43) Pub. Date: Jan. 28, 2010

(54) BULK MODE RESONATOR

(75) Inventors: Cédric Durand, Saint Martin D'Heres (FR); Fabrice Casset, Tencin (FR)

Correspondence Address: STMicroelectronics Inc.;c/o WOLF, GREENFIELD & SACKS, P.C., 600 Atlantic Avenue, BOSTON, MA, 02210-2206, US

(73) Assignees: STMicroelectronics S.A., Montrouge (FR); Commissariat A L'energie Atomique, Paris (FR)

(21) Appl. No.: 12/499,653

(22) Filed: Jul. 8, 2009

(30) Foreign Application Priority Data
Jul. 11, 2008 (FR) 08/54737

(51) Int. Cl. H01P 7/10

(52) U.S. Cl. 333/219.1

(57) ABSTRACT

A resonator including a resonant element having a bulk and columns of a material having a Young's modulus with a temperature coefficient having a sign opposite to that of the bulk.

### CROSS REFERENCE TO RELATED APPLICATIONS

This application claims the priority benefit of French patent application number 08/54737, filed on Jul. 11, 2008, entitled “BULK MODE RESONATOR,” which is hereby incorporated by reference to the maximum extent allowable by law.

### BACKGROUND OF THE INVENTION

1. Field of the Invention

The present application relates to micro-electromechanical systems. More specifically, the present application will be described as applied to structures and methods for manufacturing bulk mode resonators.

2. Discussion of the Related Art

To form time bases, many circuits use oscillators comprising a quartz. Such oscillators have a high quality factor on the order of 100,000, and a temperature-stable resonance frequency. They however have the disadvantage that their resonant frequency range is limited to values smaller than some hundred megahertz, typically 60 MHz. Further, they are difficult to integrate with microelectronic technologies due to their large sizes and to the use of manufacturing methods incompatible with the monolithic forming of circuits in a semiconductor substrate.

To reach higher frequencies and decrease power consumption levels, theoreticians have suggested to replace quartz oscillators with resonant micro-electromechanical systems, especially bulk mode resonators.

FIG. 1A is a simplified partial top view of a bulk mode resonator. FIG. 1B is a cross-section view along plane B-B of FIG. 1A. FIG. 1C is a cross-section view of FIG. 1A along plane C-C.

The resonator comprises a resonant element 1. Element 1 is formed of a bar-shaped portion of a single-crystal or multiple-crystal semiconductor material having a rectangular cross-section. Element 1 is attached to at least one anchor area 2 by arms 4. Arms 4 have minimum dimensions and are arranged to contact element 1 at the level of vibration nodes thereof. Element 1 having a rectangular cross-section, arms 4 are aligned along a neutral vibration level line 5 illustrated in dotted lines.

Apart from its connection with arms 4, element 1 is surrounded with an empty space 8. Electrodes 10 and 11 are placed symmetrically opposite to element 1 on either side of neutral line 5.

As illustrated in FIGS. 1B and 1C, the described structure is formed in a thin single-crystal silicon layer resting on a silicon wafer 13 with an interposed insulating layer 15. The portion of interval 8 separating element 1 from support 13 results from the partial removal of insulator 15. Element 1, anchors 2, and electrodes 10 and 11 are made in the thin silicon layer.

The resonator operation is the following. Element 1 being at a first voltage, electrodes 10 and 11 are set to a second voltage. The voltage difference between element 1 and electrodes 10 and 11 creates an electrostatic force which causes a deformation of the crystal lattice of element 1. Element 1 then enters a bulk vibration mode at its resonance frequency, which corresponds to a bulk wave oscillation around central neutral line 5 of element 1. The deformation of element 1 causes a variation of the capacitance of the capacitor formed by element 1 and electrodes 10 and 11. This capacitance variation may be detected at the level of electrode 10 or 11.

Theoretically, it is thus possible to obtain resonators having resonance frequencies which vary within a range from between 10 and 300 MHz up to between 1.5 and 3 GHz.

Such resonators have the theoretical advantages of having a lower power consumption than quartz oscillators and of being easily integrable.

In practice, the use of such bulk mode resonators, especially as time bases, comes up against various limits, in particular their high sensitivity to temperature variations.

Resonators having high frequencies greater than some hundred megahertz are particularly sought for, for time bases placed in portable devices such as telephones or computers. In such devices, the temperature increase in operation may be significant. Standards set a maximum value of the temperature coefficient of frequency (TCf) of a few parts per million per degree Celsius (ppm/° C.) only.

For the semiconductor materials forming resonant element 1, the resonance frequency has a negative temperature coefficient TCf which has an absolute value much greater than the limits sets by the standard. Thus, for silicon, the frequency has a temperature coefficient TCf ranging between −12 and −30 ppm/° C.

### SUMMARY OF THE INVENTION

At least one embodiment of the present invention aims at providing bulk mode resonator structures and methods for manufacturing said structures, which overcome the disadvantages of known devices.

In particular, at least one embodiment of the present invention aims at providing bulk mode resonators with an oscillation frequency having a temperature coefficient limited to a few ppm/° C. only.

At least one embodiment of the present invention also aims at providing bulk mode resonators with a positive temperature coefficient.

An embodiment of the present invention provides a resonator comprising a resonant element comprising a bulk and columns of a material having a Young's modulus with a temperature coefficient having a sign opposite to that of the bulk.

According to the present invention, resonator is used in a broad sense to designate any microelectromechanical system comprising a deformable element.

According to an embodiment of the present invention, the resonator is a bulk mode resonator.

According to an embodiment of the present invention, the columns extend perpendicularly to the vibration direction of the bulk waves.

According to an embodiment of the present invention, the columns are distributed in the element along the direction(s) of expansion/compression of the element.

According to an embodiment of the present invention, a central portion of the element is without columns.

According to an embodiment of the present invention, a peripheral portion of the element is without columns.

According to an embodiment of the present invention, the columns are present in the element in a proportion ranging between 10 and 60% by volume.

According to an embodiment of the present invention, the columns are present in the element in a proportion of 40% by volume.

According to an embodiment of the present invention, the bulk is made of silicon, of silicon-germanium, of gallium arsenide, of silicon carbide, or of diamond carbon.

According to an embodiment of the present invention, the material forming the columns is silicon oxide, aluminum oxide, or a silicon oxynitride.

At least one embodiment of the present invention also provides a method for forming a resonator in a substrate, comprising a step of forming, in a portion of the substrate intended to form a resonant element, columns of a material having a Young's modulus with a temperature coefficient of a sign opposite to that of the substrate.

According to an embodiment of the present invention, the forming of the columns comprises the successive steps of:

forming openings across the entire thickness of the substrate portion intended to form the resonant element; and

depositing in the openings a material having a temperature coefficient of its Young's modulus of a sign opposite to that of the material forming the substrate.

According to an embodiment of the present invention, the substrate is a substrate on insulator and the following depositions are performed:

before the deposition of the material having a temperature coefficient of its Young's modulus of a sign opposite to that of the material forming the substrate, at least at the bottom of the openings, that of a thin layer of a first material selectively etchable over the insulator of the substrate on insulator; and

after the deposition in the openings of the material having a Young's modulus temperature coefficient of a sign opposite to that of the material forming the substrate, that of a layer of a second material selectively etchable over said insulator of the substrate on insulator.

The foregoing objects, features, and advantages of the present invention will be discussed in detail in the following non-limiting description of specific embodiments in connection with the accompanying drawings.

### BRIEF DESCRIPTION OF THE DRAWINGS

FIGS. 1A, 1B, and 1C illustrate a known bulk mode resonator;

FIG. 2A illustrates, in partial simplified top view, a bulk mode resonator according to an embodiment of the present invention;

FIGS. 2B, 2C, and 2D are cross-section views of FIG. 2A along planes B-B, C-C, and D-D, respectively;

FIG. 3 is a top view illustrating a bulk mode resonator according to another embodiment of the present invention;

FIG. 4 is a top view illustrating a bulk mode resonator according to another embodiment of the present invention;

FIGS. 5A to 5F are partial simplified cross-section views which illustrate successive steps of a method for manufacturing a bulk mode resonator according to an embodiment of the present invention.

### DETAILED DESCRIPTION

For clarity, as usual in the representation of microelectromechanical systems, the various drawings are not to scale.

To overcome the significant frequency drop of a bulk mode resonator when the temperature increases, various solutions have been provided.

A solution is to modify the shape of element 1 by, for example, giving it the shape of a fork, of a plate or of a disk. However, a shape modification has a limited effect and does not enable to sufficiently decrease or to limit temperature coefficient TCf to be able to provide an operation at a steady high frequency when the temperature varies.

US patent application 2004/0207489 describes another solution based on the fact that, since the resonant frequency of the resonant element is a function of the square root of its Young's modulus E, temperature coefficient TCf is a function of temperature coefficient TCE of Young's modulus E. To compensate for the effects of the frequency variation according to temperature, the document provides coating the resonant element with a material having a Young's modulus with a temperature coefficient TCE of a sign opposite to that of the material forming the resonant element. Thus, a silicon element is coated with a silicon oxide sheath having a positive temperature coefficient TCE.

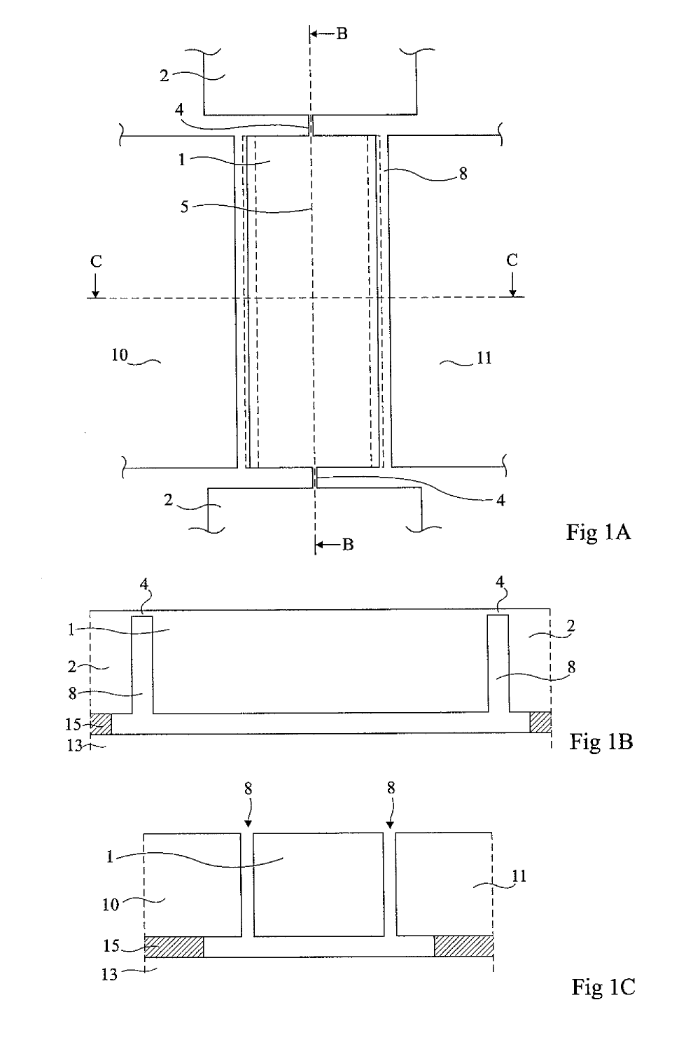

This solution however comes up against the significant amount of silicon oxide necessary to coat the element to obtain a general composite material with a coefficient TCf which is either zero or negative by a few ppm/° C. only. Thus, the inventors have determined that, to fulfill the desired condition of a general temperature coefficient TCf on the order of −0.2 ppm/° C. in a temperature range from −15 to +85° C. for a bar-shaped single-crystal silicon resonant element of rectangular cross-section similar to that of FIGS. 1A-C, of a 3-μm thickness for a 42-μm width, and having a resonant frequency on the order of 100 MHz, the resonant element should be coated with an oxide thickness ranging between 1.5 and 2 μm. The forming of such an oxide thickness poses many manufacturing problems. Further, such a sheath significantly interferes with the vibration of the element and the detection thereof. Indeed, given its significant thickness, the sheath becomes the majority insulator of the virtual capacitor between the resonant element and the electrodes. The sheath forms an insulator between the electrodes and the elements, which significantly decreases electromechanical transduction effects, thus making the electrostatic detection very difficult, or even impossible.

Other solutions comprise electronically correcting the frequency, especially by means of phase-locked loops. Such solutions are too bulky and power-consuming to be implemented in battery-powered portable devices. They further introduce a nonstandard oscillator phase noise, which forbids their use.

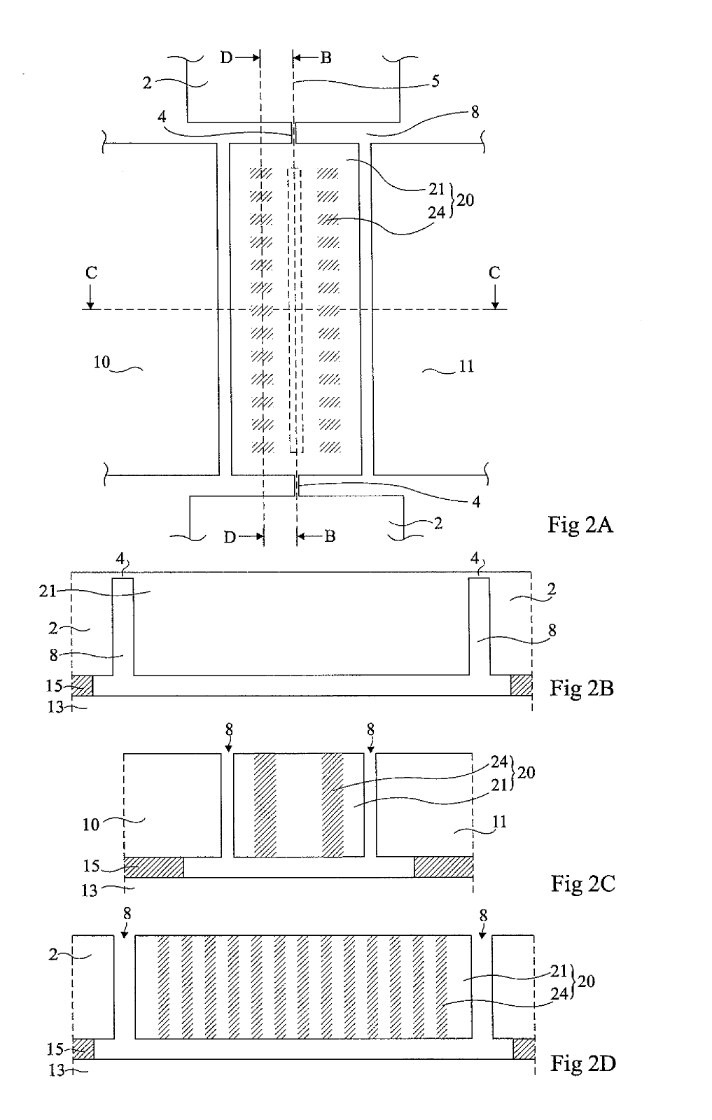

FIG. 2A illustrates in partial simplified top view a bulk mode resonator such as provided herein. FIGS. 2B, 2C, and 2D are cross-section views, respectively along planes B-B, C-C, and D-D of FIG. 2A. This resonator comprises a vibrating element 20 supported by arms 4 between anchor areas 2. This element is capable of having a bulk vibration on either side of a neutral line 5 and is arranged between electrodes 10 and 11, similarly to what has been described in relation with FIGS. 1A to 1C.

As illustrated in FIGS. 2A to 2D, vibrating element 20 comprises a single-crystal semiconductor material bulk 21 crossed by columns 24 of a material having a Young's modulus E with a temperature coefficient TCE opposite to that of semiconductor bulk 21. For example, assuming that bulk 21 is single-crystal silicon with a Young's modulus having a temperature coefficient TCE on the order of −67.5 ppm/° C., columns 24 are at least partially formed of silicon oxide (SiO₂) having a temperature coefficient TCE on the order of +185 ppm/° C.

As illustrated in FIGS. 2C and 2D, columns 24 extend across the entire thickness of bulk 21 perpendicularly to the bulk wave propagation direction.

Columns 24 are preferably distributed in element 20, except in a central portion arranged around the neutral line and in a peripheral portion of element 20, so as to have, between two columns 24, a continuous portion of bulk 21 thoroughly crossing element 20 in its expansion/compression direction.

Thus, as illustrated in FIG. 2A, as seen in cross-section view along neutral line B-B, the resonator structure is not modified with respect to the resonator of FIGS. 1A to 1C. For an element 20 of a width on the order of 40 μm, columns 24 are excluded from a rectangular central portion having a width of approximately 1 μm centered on neutral line 5. The peripheral exclusion area of a width of approximately 1 μm is illustrated in FIGS. 2A, 2C, and 2D. This peripheral area is maintained free of columns to enable an electric and mechanical continuity on the edges of the resonant element.

Columns 24 may have, in top view, a regular shape, for example, a circular, square, or diamond shape.

Columns 24 may also have, in top view, a cross-section having one dimension which is greater than another, for example, an elliptic shape or, as illustrated in FIG. 2A, a rectangular shape. In this case, columns 24 are arranged so that the largest dimension of their section is oriented in the bulk wave propagation direction.

Columns 24 have a width of at most 1 μm, preferably from 300 to 700 nm, for example, approximately 500 nm.

Elongated columns 24 may be replaced with a succession of sub-columns having the smallest possible dimensions.

The proportion of columns 24 with respect to bulk 21 in element 20 ranges between 10 and 60%, for example, 40%.

The width of element 20 varies according to the desired resonant frequency. Thus, for a frequency on the order of 10 MHz, element 20 will have a width on the order of 100 μm and, for a frequency on the order of one gigahertz, it will have a width of approximately 10 μm. The dimensions of the peripheral and central areas then vary between 1.5 μm and 0.5 μm.

The inventors have shown that a bulk mode resonator having its vibrating element 20 comprising columns 24 embedded in a semiconductor bulk 21, with columns 24 being made of a material having a coefficient TCE of a sign opposite to that of bulk 21, behaves as a composite material having a coefficient TCE equal to the combination of coefficients TCE of the two materials, weighted by their respective volume proportions.

It is thus possible to adjust temperature coefficient TCf of the frequency at a value smaller than a few ppm/° C. Very advantageously, the present invention also provides resonators having a positive coefficient TCf. Then, when the temperature increases, the frequency also increases. The frequency increase induces a shortening of the times required for one operation, and thus of the operating time, which decreases heating risks.

Further, the deposited thickness of the material of columns 24 is limited to at most the half-length of columns 24, which decreases manufacturing costs.

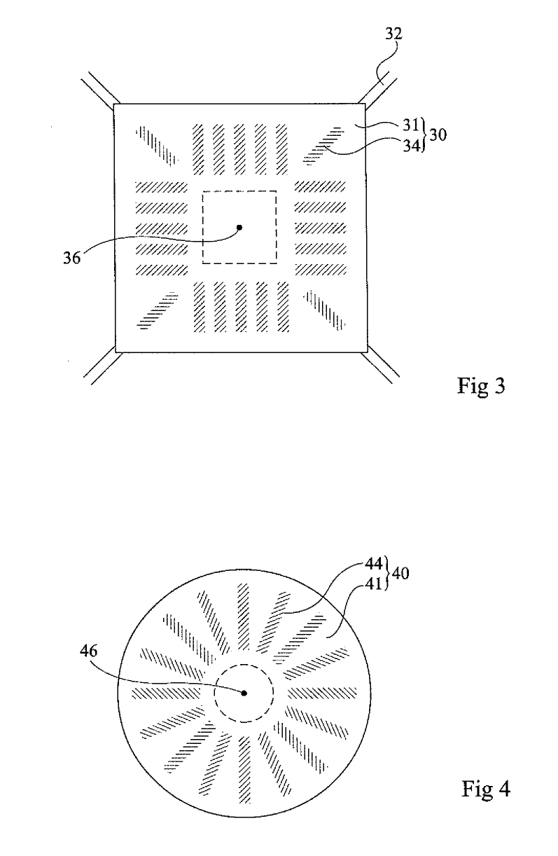

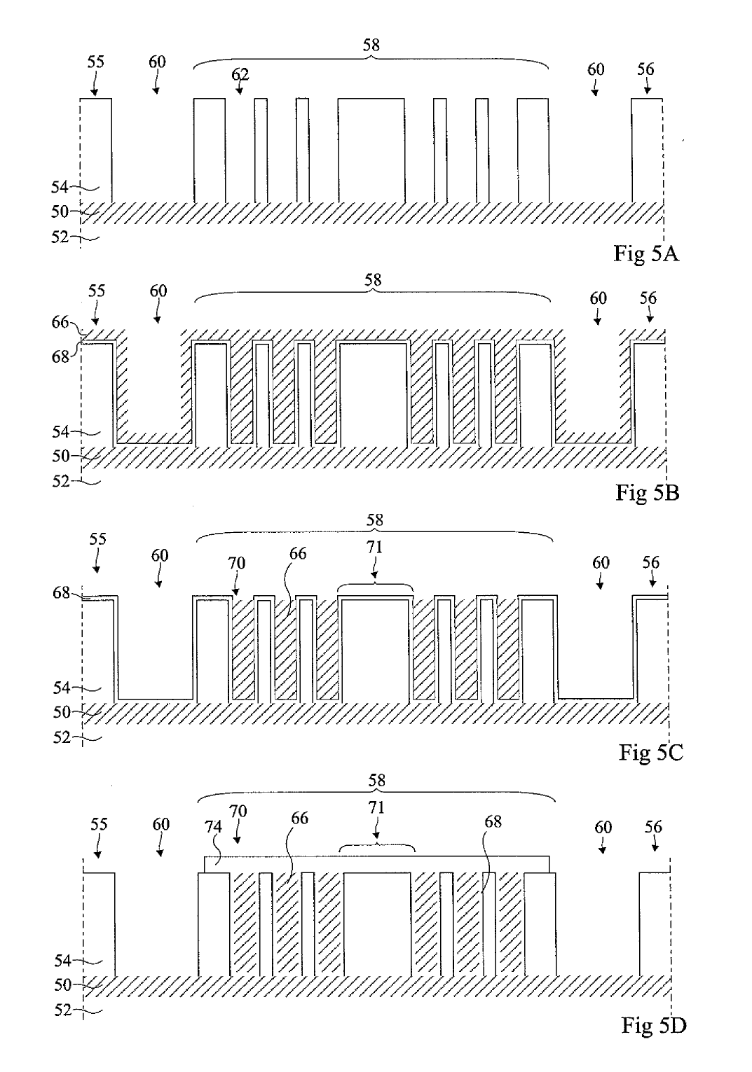

The forming of such columns is not limited to a specific resonator form. Thus, FIGS. 3 and 4 illustrate other embodiments of the present invention.

FIG. 3 is a top view of a bulk mode resonator 30 comprising a resonant element in the form of a square plate. Plate 30 is formed of a bulk 31 made of a single-crystal semiconductor material attached to anchors, not shown, by arms 32 which protrude from bulk 31 at the level of the vibration nodes formed by the four corners of plate 30.

Columns 34 are formed across the entire thickness of plate 30. Preferably, columns 34 extend radially along the expansion/compression direction of element 30.

Columns 34 are regularly distributed in an area comprised between central and peripheral exclusion areas centered on the vibration node formed by geometric center 36 of plate 30.

The dimensions of plate 30 vary according to the desired resonant frequency. Thus, plate 30 has one side ranging from 500 μm for a frequency on the order of 10 MHz to between 5 and 10 μm for a frequency on the order of one gigahertz. The width of the exclusion areas varies from 1 to 2 μm for a frequency ranging from some ten megahertz to between 0.2 and 0.5 μm for frequencies on the order of one gigahertz. For example, for a plate 30 having a 30-μm side for a frequency on the order of some hundred megahertz, the exclusion areas have a width on the order of from 1 to 1.5 μm.

FIG. 4 illustrates in top view a bulk mode resonator according to another embodiment of the present invention. The resonator comprises a disk-shaped resonant element 40 formed of a single-crystal semiconductor bulk 41 in which columns 44 are embedded. Columns 44 are distributed around the node formed by center 46 of the disk. Columns 44 are arranged so that their main dimension in top view is parallel to the bulk wave propagation direction. Similarly to the embodiments of FIGS. 2 and 3, an exclusion area in which no column 44 is formed extends around central node 46. Similarly, columns 44 are excluded from a peripheral area.

Thus, the resonator may comprise an element having a diversity of shapes. It will be within the abilities of those skilled in the art to adapt the position of the columns according to what has been previously described so that they extend, outside of central and peripheral exclusion areas, symmetrically around a central vibration node. Preferably, columns 34 extend radially along the bulk wave propagation direction.

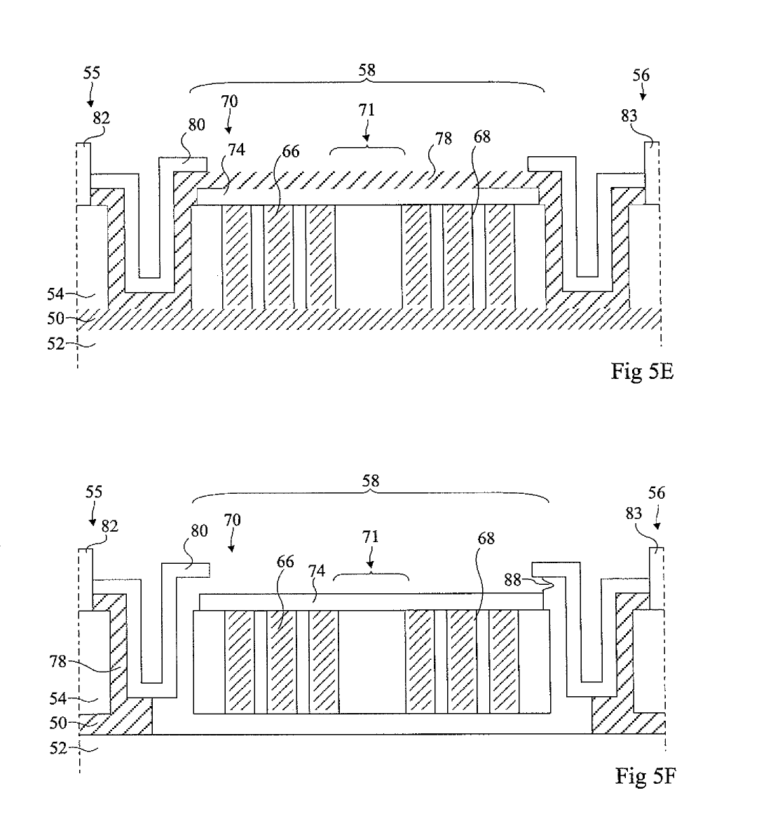

FIGS. 5A to 5F are cross-section views which illustrate as an example different steps of a method for manufacturing a bulk wave resonator similar to that of FIGS. 2A to 2D. FIGS. 5A and 5F are views along a cross-section plane corresponding to plane C-C of FIG. 2A.

It is started from a semiconductor wafer of silicon-on-insulator type in which an insulator 50 separates a slice 52 of a semiconductor material from a thin single-crystal layer of the same semiconductor material or of another semiconductor material 54.

As illustrated in FIG. 5A, the contours of anchor areas (not shown), of a resonant element 58, and of electrodes 55 and 56 are first defined in layer 54, by digging of trenches 60. During this step, openings 62 are also dug at the locations where columns are desired to be formed according to the present invention. Trenches 60 and openings 62 are formed across the entire thickness of layer 54. Trenches 60 and openings 62 may be formed by using the same mask or two successive masks.

At the next steps, illustrated in FIG. 5B, at least one layer of a material 66 having a Young's modulus E with a temperature coefficient TCE of a sign opposite to that of the material forming layer 54 is deposited.

Before the deposition of material 66, a thin layer of a material 68 capable of being unaffected by an etching of insulator 50 may be deposited. Layer 68 is only provided when material 50 is not selectively etchable over material 66, in particular when material 66 is identical to insulator 50, for example, silicon oxide. According to a variation, not shown, the layer is only deposited at the bottom of openings 62.

At the next steps, illustrated in FIG. 5C, material 66 is removed from trenches 60 and from the planar surfaces of layer 54. Material 66 is only maintained in openings 62 of FIG. 5A that it totally fills, forming columns 70. As compared with the resonator seen in top view in FIG. 2A and in cross-section view in FIG. 2C, it should be noted that columns 70 are distributed on either side of a central region 71 without columns and that, on either side of this exclusion region 71, each elongated column 24 of FIG. 2 is replaced with three aligned columns 70.

At the next steps illustrated in FIG. 5D, a thin layer 74 of a material selectively etchable over the materials forming insulator 50 and columns 70 is deposited. Preferably, layer 74 is made of a same material as layer 68. Layer 74 is etched to only be maintained above columns 70. Layer 68 is then removed from trenches 60 and from all the surfaces unprotected by layer 74. Preferably, layer 74 is of same nature as layer 68 and layer 68 is removed at the same time as layer 74 is etched.

The method then carries on with resonator electrode forming steps, with a reserved interval between electrodes 55 and 56 and element 58, as well as the forming of electrode contacts.

For this purpose, as illustrated in FIG. 5E, a sacrificial layer 78 of a thickness equal to the width which is desired to be given to the interval separating electrodes 55 and 56 of resonant element 58 is conformally deposited. Preferably, to simplify the disengagement of element 58, layer 78 is of same nature as layer 50. Then, a conductive layer 80 is deposited. Layer 80 is etched to be removed from above the upper surface of element 58.

Layer 80 may be placed above a small peripheral portion of element 58.

At the level of electrodes 55 and 56, layer 80 and layer 78 are opened to form electrode contacts 82 and 83 by deposition and etching of a conductive layer, preferably metallic.

At the next steps, illustrated in FIG. 5F, layers 78 and 50 are removed. Preferably, layers 78 and 50 are made of a same material and are removed by a same process. The removal of insulator 50 and of layer 78 enables to disengage resonant element 58 from the resonator. During this removal, buried insulator 50 may be at least partially removed under electrode 80, which is of no effect on the device operation. The removal of layer 78 enables to ensure the forming of interval 88, in which element 58 can vibrate close to the electrodes. The presence at the bottom of columns 70 of layer 68 and of layer 74 on columns 70 enables to protect material 66 of columns 70 during this step of disengagement of element 58. The nature of 74 and/or its thickness are selected to protect material 66 forming columns 70 during the removal of layer 78.

An advantage of the described manufacturing method is that it uses a standard substrate on insulator SOI in which the thickness of insulator 50 ranges between 100 nm and 3 μm, and typically is on the order of 1 μm. Similarly, all the layers used have dimensions compatible with standard technological processes. In particular, to obtain an equivalent stabilization of coefficient TCf, the method provided by US patent application 2004/0207489 would impose a sheath with a thickness from four to ten times as large.

As an example, the dimensions and the natures of the different layers are the following.

Wafer 52 is a single-crystal silicon wafer, for example, of a thickness ranging between 300 and 750 μm, for example, 750 μm.

Insulator 50 is a silicon oxide layer of a thickness ranging between 100 nm and 3 μm, for example, 1 μm.

Layer 54 is a single-crystal silicon layer of a thickness ranging between 1 and 20 μm, for example, 3 μm.

Trenches 60 have a width which is reduced according to twice the sum of the halves of the thicknesses of layers 78 and 80.

Openings 62 have a width and a diameter of at most 1 μm. Preferably, the width of the openings is decreased to the minimum possible value according to the methods used to etch layer 54.

Material 66 forming columns 70 has a temperature coefficient TCE of Young's modulus E of a sign opposite to that of the material forming layer 54. For example, if layer 54 is silicon having a Young's modulus of 165.6 GPa and a coefficient TCE on the order of −67.5 ppm/° C. at 30° C., material 66 is a silicon oxide layer having a modulus E of 73 GPa and a coefficient TCE of +185 ppm/° C. Material 66 may also be aluminum oxide (Al₂O₃) or a silicon oxynitride (SiON).

Protection layer 68 is a layer of a thickness that may range from a few nanometers to a few tens of nanometers of a material having very selective etch characteristics over insulator 50 and layer 78. Its thickness is very small as compared to that of material 66 forming columns 70 to avoid interfering with the behavior of resonant element 58 and especially to avoid affecting the resonance frequency or temperature coefficients TCf and TCE. For example, if insulator 50 and layer 78 are made of silicon oxide, material 68 may be a single-crystal or multiple-crystal silicon layer or an insulating layer, for example, a silicon nitride layer (Si₃N₄), a hafnium oxide layer (HfO₂), a layer of a hafnium and zirconium alloy oxide (HfZrO₂), an aluminum oxide layer (Al₂0₃), a titanium nitride layer (TiN), a tantalum nitride layer (TaN), or again a tantalum oxide layer (Ta₂O₅).

Protection layer 74 is a layer of a material having etch characteristics very selective over insulator 50 and layer 78. Layer 74 is selected from among the same materials as layer 68. Preferably, the material forming layer 74 is identical to the material of layer 68. Layer 74 has a thickness of a few tens of nanometers. In the same way as for layer 68, this thickness is reduced to avoid affecting the behavior of element 58, especially so that only bulk 54 and material 66 forming columns 70 affect its temperature coefficients TCE and TCf. According to a variation, to reduce its effects, layer 74 is not a continuous layer but is removed at the step of FIG. 5D to only leave in place an individual cap above each column 70.

Sacrificial layer 78 has a thickness ranging between 20 and 500 nm. For example, it is a silicon oxide layer.

It has been considered that protection layers 68 and 74 were not etched during the removal of insulator 50 and of sacrificial layer 78. However, according to a variation, their nature and thickness are selected according to the materials forming insulator 50 and layer 78 and to their etch mode, so that their etch speed is much slower. Thus, during the total removal of layer 78 and the removal of insulator 50 under element 58, protection layers 68 and 74 are etched, but only partially and after disengaging of element 58, a few nanometers of thickness of layers 68 and 74 remain in place. This enables to reduce the impact of the protection layers on resonant element 58.

It should also be noted that in relation with FIG. 5D, it has been considered that protection layers 68 and 74 are totally removed from trenches 60. Protection layers 68 and 74 may however be only partially removed to only partially expose insulator 50 at the bottom of trenches 60.

Specific embodiments of the present invention have been described. Different variations and modifications will occur to those skilled in the art. Thus, it should be understood by those skilled in the art that the present invention has been described in the context of a silicon technology. However, layer 54 may be made of another single-crystal or multiple-crystal semiconductor material. In particular, layer 54 may be a stressed silicon-germanium layer, a germanium layer, or a layer of any other material or semiconductor alloy such as gallium arsenide. Layer 54 may also be made of a semiconductor material with a wide band gap such as silicon carbide (SiC) or diamond carbon. Further, it has been previously considered that the resonator is formed of a substrate on insulator in the thin layer. However, the resonator may be formed in a solid substrate.

The resonator may also be formed in a non-semiconductor material.

Dimensions have been indicated within the framework of a given technological process. It will be within the abilities of those skilled in the art to adapt the dimensions of the different elements according to the manufacturing constraints.

It will also be within the abilities of those skilled in the art to form columns according to the present invention based on the previously-disclosed design rules, in any type of resonator, whatever the shape of the semiconductor bulk and the dimensions thereof.

It will also be within the abilities of those skilled in the art to modify the structure of the resonant element according to a given application. Similarly, the anchoring modes of the resonant elements may be modified. Thus, plate 30 of FIG. 3 has been described as being attached by four arms 32. However, plate 30 may be only attached to a single arm or laid on a central anchor solid with the center of plate 30.

Further, it will be within the abilities of those skilled in the art to adapt the materials used to a given manufacturing process.

Moreover, the present invention has been described as applied to bulk mode resonators. However, the forming in the bulk of a microelectromechanical system of column of a material having a temperature coefficient of Young's modulus of a sign opposite to that of the bulk may be used in all other types of resonators such as flexion resonators and more generally in any type of microelectromechanical systems.

What is claimed is:

1. A resonator comprising a resonant element comprising a bulk and columns of a material having a Young's modulus with a temperature coefficient having a sign opposite to that of the bulk.

2. The resonator of claim 1, wherein the resonator is a bulk mode resonator.

3. The resonator of claim 1, wherein the columns extend perpendicularly to the vibration direction of the bulk waves.

4. The resonator of claim 1, wherein the columns are distributed in the element along the direction(s) of expansion/compression of the element.

5. The resonator of claim 1, wherein a central portion of the element is without columns.

6. The resonator of claim 1, wherein a peripheral portion of the element is without columns.

7. The resonator of claim 1, wherein the columns are present in the element in a proportion ranging between 10 and 60% by volume.

8. The resonator of claim 7, wherein the columns are present in the element in a proportion of 40% by volume.

9. The resonator of claim 1, wherein the bulk is made of silicon, of silicon-germanium, of gallium arsenide, of silicon carbide, or of diamond carbon.

10. The resonator of claim 1, wherein the material forming the columns is silicon oxide, aluminum oxide, or a silicon oxynitride.

11. A method for forming a resonator in a substrate, comprising a step of forming, in a portion of the substrate intended to form a resonant element, columns of a material having a Young's modulus with a temperature coefficient of a sign opposite to that of the substrate.

12. The method of claim 11, wherein the forming of the columns comprises the successive steps of:
forming openings across the entire thickness of the substrate portion intended to form the resonant element; and
depositing in the openings a material having a temperature coefficient of its Young's modulus of a sign opposite to that of the material forming the substrate.

13. The method of claim 11, wherein the substrate is a substrate on insulator and wherein the following depositions are performed:
before the deposition of the material having a temperature coefficient of its Young's modulus of a sign opposite to that of the material forming the substrate, at least at the bottom of the openings, that of a thin layer of a first material selectively etchable over the insulator of the substrate on insulator; and
after the deposition in the openings of the material having a temperature coefficient of Young's modulus of a sign opposite to that of the material forming the substrate, that of a layer of a second material selectively etchable over said insulator of the substrate on insulator.
